(19) United States
(12) Patent Application Publication
(10) Pub. No.: US 2009/0155755 A1
(43) Pub. Date: Jun. 18, 2009

(54) TIME-BASED LEARNING AND RECALL PROCESS

(76) Inventor: Donald R. Kracke, Indio, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/330,309

(22) Filed: Dec. 8, 2008

Related U.S. Application Data
(60) Provisional application No. 61/013,024, filed on Dec. 12, 2007.

(51) Int. Cl. G09B 19/00; G09B 3/00

(52) U.S. Cl. 434/236; 434/322

(57) ABSTRACT

A time-based learning and recall process is provided. The process associates a plurality of tasks or thoughts with a number on a flashcard that accordingly corresponds to a specific hourly time block memorized in conjunction with an adjustable clock. After memorization, the user is reminded of that task or process corresponding to that particular hour of the day as identified with, for example, a timepiece face.

### BACKGROUND OF THE INVENTION

The present invention relates to a time-based learning and recall process. More specifically, the present invention relates to a time-based learning and recall process that associates thoughts with a specific hour of the day.

Learning assistant tools and techniques are generally known in the art. Tools and techniques may include computerized systems, training aids, or learning programs that utilize hearing, speech, reading, writing, mathematics and language skills. The learning assistant tools are generally designed for interactivity and are adapted to maximize the effectiveness and efficiency of learning, retaining and retrieving information.

Conventional learning methods use repetitive, rote learning, which primarily includes teacher and student interaction. For example, rule-based learning systems typically have teachers that repetitively present words to a student in an attempt to train recognition of a spoken language. Pictures, sounds, or other perceivable information may optionally be presented to the student along with the words. It is up to the teacher to decide the pace and content of each student lesson. The teacher effectively controls the subjective progression of the student. The downside to such rule-based learning is the required interaction and guidance of a teacher. Furthermore, the rules may not be applicable to everyday activities and may fail to automatically trigger responses from environmental conditions.

Alternative learning aids known in the art may encompass partially automated or computerized training systems. These computers run game-type interactive programs that require students to answer questions. The primary deficiency of such systems includes the lack of flexibility for students having different learning styles or capabilities. The learning environment is rigid and the students are forced to adapt to the training system—the training system is not adaptable to each user. In effect, these computer programs provide little, if any, improved learning assistance in memorizing key tasks as compared to the traditional teacher-to-student interaction.

Still other traditional learning systems use association of two items to trigger responses. In these cases, students receive an item or items that are learned in an associated pair format. These cue-and-response systems rely heavily on the motivation and metacognitive skills of the student. With such reliance comes varying degrees of effectiveness and efficiency. There is really no good way to ensure that the student maintains the knowledge and skills over an extended time period, especially if the paired items are not readily accessible or frequently tied together outside the learning environment. This is especially critical as a student may not be able to actually retrieve the knowledge or skills automatically at some future date without some form of association outside the classroom.

The methods and learning processes described above are only marginally effective for learning, retaining and retrieving knowledge and skills. These methods require users to schedule and manage learning, reviewing and testing processes. Organization can consume a portion of the cognitive work load and thereby reduce learning efficiency. Additionally, the above methods train or teach skills to a certain level in exchange for the student expending significant cognitive effort to remember a previously learned item. Accordingly, such conventional methods have not been successful in training students to automatically recall or associate learned paired items outside the learning environment. It is desirable to design a learning system to elicit rapid responses from the student without conscious effort or attention.

In particular, nothing in the prior art addresses or suggests a time-based learning process that triggers memory recall in association with time. Certainly nothing in the prior art addresses a cognitive ability to recall such information at a particular time of day.

Therefore, there is a need for a learning and recall process utilizing readily available components found in the every day environment. Such a recall process should be time-based to ensure meaningful success of the students as activities associated with the specific time of day are readily accessible outside of the learning environment. There is substantial room for improvement in the way of memorizing specific tasks for completion at certain times of the day. The present invention is particularly suitable as a reminder for students or users to recall and actively engage in or disengage from activities at a certain time of the day.

### SUMMARY OF THE INVENTION

The present invention is directed to a process for time-based memorization and recall. The process begins with the step of providing a timepiece displaying hours of the day. The timepiece is preferably an analog clock, a digital clock, or a timepiece cover. The analog clock or timepiece cover has a face displaying numbers corresponding to hours of the day and a movable hour hand, whereby the hours of the day are adjustable. The timepiece preferably displays either twelve or twenty-four hours.

The next step of the process involves associating a particular hour of the day with a task or thought to be memorized. A plurality of flashcards are then prepared wherein each flashcard has one particular hour of the day on a first side and the task or thought associated with the particular hour of the day on a second side. The quantity of flashcards preferably equals the number of hours of the day displayed on the timepiece.

The next step of the process involves memorizing the association between each hour of the day and the associated task or thought. The step of memorizing includes manually adjusting the hour of the day displayed on the timepiece. The memorizing step also involves reviewing the flashcards in conjunction with the timepiece. Once memorization is complete one may be tested by recalling each task or thought at the associated hour of the day.

### BRIEF DESCRIPTION OF THE DRAWINGS

The accompanying drawings illustrate the invention. In such drawings:

FIG. 1 illustrates a flowchart embodying the time-based learning and recall process of the present invention;

FIG. 2 is a top view of a sample timepiece face;

FIG. 3 illustrates a set of twelve flashcards corresponding to the twelve hours on the timepiece face of FIG. 2;

FIG. 4 illustrates association of four o'clock with a flashcard numbered “4”; and

FIG. 5 illustrates a timely reminders instruction book having a manually adjustable timepiece face.

### DETAILED DESCRIPTION OF THE PREFERRED EMBODIMENT

The present invention is for a time-based learning and recall process that incorporates associating a particular time of the day with a task or thought. The process of the present invention begins by acquiring a timepiece that preferably has twelve numbered hours on its face. Each of these twelve hours are associated with a task or thought that is written on the back of a flashcard having an associated number corresponding to the hour on the timepiece face. The task and thoughts are to be understood and associated with the applicable number and memorized in relation to the hour of day.

Optionally, a mentor may work with the user or student to organize the memorization schedule. The mentor may set up a schedule and otherwise guide or instruct a student or students in the application of the time-based learning and recall process of the present invention. Additionally, an instruction book having a timepiece cover with movable hands is included to better facilitate practice and memorization. The timepiece cover and movable hands allow the user to quickly change hourly time blocks visually associated with each number on the flashcards.

The time-based learning and recall process is finalized when the student memorizes each task or thought associated with the corresponding hour on the timepiece face. Preferably, the user memorizes twelve tasks or thoughts associated with each hour on a standard 12-hour timepiece face. Accordingly, the user will be reminded of the task or thought during that specific hour block, in view of completing the time-based learning and recall process of the present invention. This memorization process is particularly efficient as time is prevalent throughout the environment, especially outside the classroom.

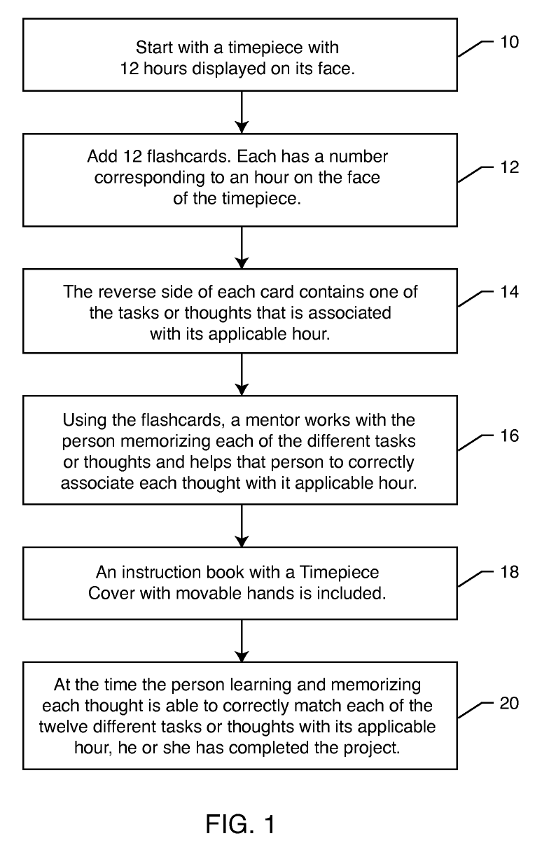

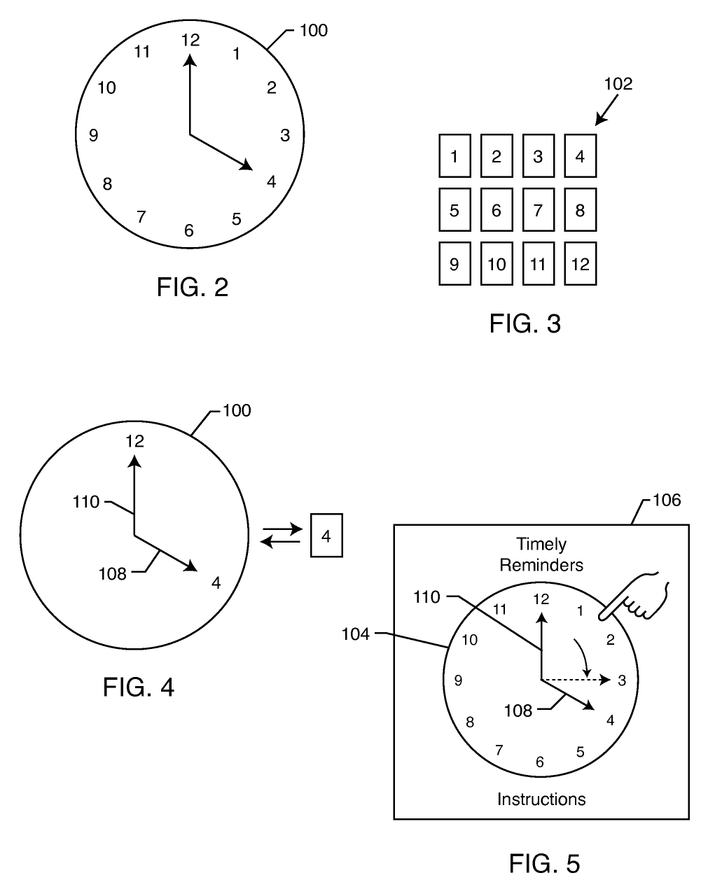

As shown in the exemplary flowchart for the purpose of illustration, the present disclosure for a time-based learning and recall process is generally illustrated in FIG. 1. The first step in the time-based learning and recall process is acquiring a timepiece 10 having the hours of the day, preferably 1 through 12, on the face. A timepiece face 100, as shown in FIG. 2, is used in combination with a set of flashcards 102 (FIG. 3) to associate an activity with a particular time of day. The numbers on the timepiece face 100 visually provide immediate identification of the time of day, which is the basis for the time-based learning and recall process. Accordingly, the second step of the present invention is preparing the flashcards 12. Each flashcard has a number (e.g. 1 through 12) that corresponds to an hour of the day on the timepiece face 100. In this example, the first flashcard in the set of flashcards 102 has the number “1” on one side and the remaining cards each have the numbers “2”, “3”, etc. all the way through “12”. Appropriately, these numbers correspond to the twelve hours displayed on the timepiece face 100.

The hourly display is preferably used with a timepiece face 100 having the numbers 1 through 12 thereon. Although, the present invention for a time-based learning and recall process may utilize a different quantity of hours that vary in format. For example, a timepiece face may encompass a 24-hour time period, thus necessitating the use of 24 flashcards corresponding to each hour of the twenty-four hours on the timepiece face. Alternatively, the timepiece face and flashcards may be expressed in military time such that 10 p.m. is expressed as 22. The important aspect of the present invention is that, regardless of the number of hours utilized or the format, the quantity of flashcards should match the quantity of hours displayed on the timepiece face. Moreover, the numbers on the flashcards should also match the hours on the timepiece face to facilitate learned pair memorization.

The step of applying tasks or thoughts 14 involves adding a task or thought to the non-numbered side of each flashcard. Preferably, each task or thought applied to the set of flashcards 102 is associated with a particular time of day. In turn, the applicable number on the flashcard associates the task or thought with a corresponding hour on the timepiece face 100. The task or thought is thereafter memorized in relation to the number on the flashcard. Transitively, the task or thought is associated with an hour of the day.

A user memorizes each of the different tasks or thoughts on the set of flashcards 102 during a memorizing step 16. The tasks or thoughts are associated with the applicable number on each flashcard. For example, FIG. 4 illustrates the association of a task or thought written on the back of a flashcard having the number “4” thereon. Accordingly, the timepiece face 100 is set to four o'clock. Preferably, a mentor works with the user to better facilitate this learning and memorization process. The mentor helps the user correctly associate each task or thought with the applicable number and hour of the day. Such a mentor might be a person in charge of a business group or a scout leader that leads a Cub Scout troop. Preferably, the mentor has experience in the use of the time-based learning and recall process of the present invention. This will better enable the mentor to guide the user or users through the steps disclosed herein.

The next step involves utilizing the timepiece cover 18. A timepiece cover 104 is shown in FIG. 5 as part of an instruction book 106. The timepiece cover 104 is similar to the timepiece face 100 shown in FIG. 1. The timepiece cover 104 is used in association with the flashcards, as previously described. An hour hand 108 and a minute hand 110 on the timepiece cover 104 are movable to enable the user to easily change the identified time during the memorizing step 16. The user may therefore quickly and easily identify different time periods of the day. In an alternative embodiment, the timepiece face is an electronic device, such as a digital clock or watch. Here, again, the hours on the timepiece face should be readily changeable. Being able to quickly change among hour blocks aids in the memorization process of associating a time of the day with the tasks or thoughts applied to the set of flashcards 102 in step 14.

The step of completing the process 20, includes memorizing each task or thought such that the user can correctly match each task or thought with a corresponding hour upon recall. The time-based learning and recall process is completed when each task or thought is memorized in association with the corresponding number as associated with a particular hour of the day. Preferably, there are twelve tasks or thoughts associated with the twelve hours on a timepiece face, such as a traditional wristwatch face. The user may use the flashcards to memorize the tasks or thoughts in accordance with any method known in the art.

There are no time limits associated with the time-based learning and recall process of the present invention. The user or mentor may set up a schedule to complete the process 20 in a timely manner. Acceptable time frames for completing the time-based learning and recall process may range from hours, to days, to weeks, to months or even years. The complexity of the tasks or thoughts can range from something as simple as remembering to take a vitamin to something as complex as remembering a sequence of instructions, or more. The most important residual benefit of this time-based learning and recall process is that once each thought is memorized and associated with the applicable number, every time the user involved in the learning process checks a timepiece, the user is reminded of the task or thought associated with that particular time block. In essence, the present invention is ideal for memorizing daily routines or other items associated with a time of the day. The present invention is particularly conducive to learned pair association as time is prevalent throughout the environment, especially outside the classroom or other learning environment.

Although an embodiment has been described in detail for purposes of illustration, various modifications may be made without departing from the scope and spirit of the invention. Accordingly, the invention is not to be limited, except as by the appended claims.

What is claimed is:

1. A process for time-based memorization and recall, comprising the steps of:
providing a time piece displaying hours of the day;
associating a particular hour of the day with a task or thought to be memorized;
preparing a plurality of flash cards, each flash card having one particular hour of the day on a first side and the task or thought associated with the particular hour of the day on a second side;
memorizing the association between each hour of the day and the associated task or thought.

2. The process of claim 1, further comprising the step of recalling each task or thought at the associated hour of the day.

3. The process of claim 1, wherein the time piece is an analog clock, a digital clock, or a time piece cover.

4. The process of claim 3, wherein the analog clock or time piece cover has a face displaying numbers corresponding to hours of the day and a movable hour hand.

5. The process of claim 3, wherein the digital clock has a display whereby the hours of the day are adjustable.

6. The process of claim 1, wherein the time piece displays either twelve or twenty-four hours.

7. The process of claim 1, wherein the memorizing step comprises the step of manually adjusting the hour of the day displayed on the time piece.

8. The process of claim 1, wherein the memorizing step comprises the step of reviewing the flash cards in conjunction with the time piece.

9. The process of claim 1, wherein the quantity of flash cards equals the number of hours of the day displayed on the time piece.

10. A process for time-based memorization and recall, comprising the steps of:
providing a time piece displaying hours of the day, wherein the time piece comprises an analog clock, a digital clock, or a time piece cover;
associating a particular hour of the day with a task or thought to be memorized;
preparing a plurality of flash cards, each flash card having one particular hour of the day on a first side and the task or thought associated with the particular hour of the day on a second side;
memorizing the association between each hour of the day and the associated task or thought by manually adjusting the hour of the day displayed on the time piece.

11. The process of claim 10, further comprising the step of recalling each task or thought at the associated hour of the day.

12. The process of claim 10, wherein the analog clock or time piece cover has a face displaying numbers corresponding to hours of the day and a movable hour hand.

13. The process of claim 10, wherein the digital clock has a display whereby the hours of the day are adjustable.

14. The process of claim 10, wherein the time piece displays either twelve or twenty-four hours.

15. The process of claim 10, wherein the memorizing step comprises the step of reviewing the flash cards in conjunction with the time piece.

16. The process of claim 10, wherein the quantity of flash cards equals the number of hours of the day displayed on the time piece.

17. A process for time-based memorization and recall, comprising the steps of:
providing a time piece displaying hours of the day, wherein the time piece comprises an analog clock, a digital clock, or a time piece cover;
associating a particular hour of the day with a task or thought to be memorized;
preparing a plurality of flash cards, wherein the quantity of flash cards equals the number of hours of the day displayed on the time piece, each flash card having one particular hour of the day on a first side and the task or thought associated with the particular hour of the day on a second side;
memorizing the association between each hour of the day and the associated task or thought by manually adjusting the hour of the day displayed on the time piece and reviewing the flash cards in conjunction with the time piece.

18. The process of claim 17, further comprising the step of recalling each task or thought at the associated hour of the day.

19. The process of claim 17, wherein the analog clock or time piece cover has a face displaying numbers corresponding to hours of the day and a movable hour hand.

20. The process of claim 17, wherein the digital clock has a display whereby the hours of the day are adjustable and the time piece displays either twelve or twenty-four hours.
